(19) United States
(12) Patent Application Publication
(10) Pub. No.: US 2002/0120566 A1
(43) Pub. Date: Aug. 29, 2002

(54) Payment enabling exchange client system

(75) Inventor: Yoon Weng Tim, Penang (MY)

Correspondence Address: MEDLEN & CARROLL, LLP, 101 HOWARD STREET, SUITE 350, SAN FRANCISCO, CA, 94105, US

(73) Assignee: e-Business Exchange Pte. Ltd

(21) Appl. No.: 09/796,929

(22) Filed: Feb. 28, 2001

(51) Int. Cl. G06F 17/60

(52) U.S. Cl. 705/40

(57) ABSTRACT

The present invention provides methods and devices for facilitating bill payment. In particular, the present invention provides for electronically facilitated transactions of money between buyers and businesses over a communications network such as the Interne, while providing a convenient and secure way to conduct these types of person-to-person transactions.

### FIELD OF THE INVENTION

The present invention provides methods and devices for facilitating bill payment. In particular, the present invention provides for electronically facilitated transactions of money between buyers and businesses over a communications network such as the Internet, while providing a convenient and secure way to conduct these types of person-to-person transactions.

### BACKGROUND OF THE INVENTION

Bill preparation, payment and remittance processing are paper and labor intensive end-to-end. Billers prepare and print the bills, use special collating equipment to insert them along with promotional material into envelopes, and mail them through the post office. Consumers and small businesses write payment checks and return the turnaround portion of the bill along with the check payment either directly to the biller or to a payment lockbox, which may be run by a financial institution or service company. Once submitted, the envelopes are opened, the turnaround document is scanned using high speed Optical Character Recognition (OCR) equipment, check amounts are encoded, and a deposit is made to the biller's account. The deposited checks are sorted and returned to the consumer's bank where the consumer's account is debited. On the appropriate cycle, the checks are then enclosed with an activity statement and returned to the consumer. With all of these steps, more and more challenges are faced by many companies as the needs to meet the growing business becomes demanding and tedious.

Billers, suppliers or organizations who posses the bills, statements, invoices, debit notes, contracts or any documents that requires a payment are constantly faced with the rising cost of printing and distribution of these documents. Customers and buyers are demanding itemized bills which increases the number of pages and hence translates to higher cost and longer delivery time.

As a result, physical service centers and counters cannot cope with the growing customer base. However, increasing the number of service centers and counters means higher operating overhead and may not necessarily improve customer service. Because of these inconveniences and added costs, consumers find the traditional way of paying bills via checks, walk-in counters very inefficient and time-consuming. Likewise, businesses find reconciling payments with bills difficult and inefficient. Thus, there remains a need for methods that link these systems to the bank, whereby consumers can easily pay various bill and make electronic payments with just a click, without having to keep checks, stamps and envelopes on hand. In turn, businesses need methods that achieve cost savings as a result of not having to print and mail bills.

### SUMMARY OF THE INVENTION

The present invention provides methods and devices for facilitating bill payment. In particular, the present invention provides for electronically facilitated transactions of money between buyers and businesses over a communications network such as the Interne, while providing a convenient and secure way to conduct these types of person-to-person transactions.

In some embodiments, the present invention provides a customer (“PEX Client”) which enables any B2C systems, including but not limited to eBPP, online catalog, online store, B2B systems (e.g., e-marketplace and procurement portals), to be able to connect to a payment server (“PEX”) at bank. In particularly preferred embodiments, the PEX Client of the present invention is designed primarily to accomplish the e-business cycle. In an alternative embodiment (i.e., in a business to customer module), the present invention provides means to bring the biller, the bill payer and the bank together. In another embodiment, the present invention provides means to bring the buyer, the supplier and bank together (e.g., in business to business module).

In other embodiments of the invention, billing entities are provided with a PEX Client for replicating bills and provide information regarding payment status to a document consolidator. In some embodiments, the billing entities are linked to Document Consolidator via leased or dial-up network, while in other embodiments, the billing entities can also be linked to the Document Consolidator via the Interne. In particularly preferred embodiments, the PEX Client links a billing entity with the corresponding bank(s) by means of a registration module.

In further embodiments, each billing entity registers with a document consolidator or other bill presentment systems and provides them with information. In some embodiments, the information includes, but is not limited to a bank account to be used for payment collection. In other embodiments, the billing entities and document consolidator utilize a file transfer mode to transfer bills and/or payment status to the portal.

In still other embodiments, bills, invoices and debit notes are presented on-line over the World Wide Web or over the telephone. In these embodiments, the bill payer accesses these bills, invoices and debit notes on-line or through a phone call. In particularly preferred embodiments, bill payers connected to the Consolidators connect to the bill payer's bank via a payment enabling exchange (“PEX”) server to issue payment instructions for bills, invoices and debit notes payment.

In yet further embodiments of the present invention, banks are the financial institutions which facilitate payment via the Interne. In these embodiments, the bill payer's bank is a participating bank with the document consolidator and payment is facilitated. In certain embodiments, the bank processes the payment instructions by debiting the buyer's account and crediting the supplier's account. In particularly preferred embodiments, for all participating banks, a payment server (PEX) is installed at each bank.

### DESCRIPTION OF THE FIGURES

FIG. 1 provides a schematic showing the incorporation of the PEX Client into the bill presentation system and payment enabling exchange system of some embodiments of the present invention.

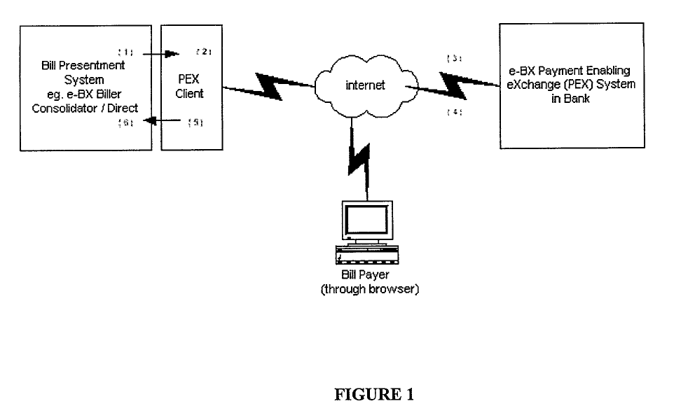

FIG. 2 provides a summary schematic showing the processes linked by the PEX Client to the bill presentation system, document consolidator, and payment enabling exchange system processes of some embodiments of the present invention.

FIG. 3 provides a schematic showing the interaction of the PEX Client with the payment enabling exchange and bank in the bill presentation and document consolidator system of some embodiments of the present invention.

### DEFINITIONS

As used herein, the term “PEX Client” refers to payment exchange for clients which allows payment of bills and other transactions.

As used herein, the term “B2C” and “business to consumer” refer to transactions between businesses (e.g., companies) and customers (e.g., end-users).

As used herein, the term “B2B” and “business to business” refer to transactions between businesses.

As used herein, the term “billing entity” refers to a business entity that provides bills, statements, invoices, debit notes, or any other instruments or documents that require payment.

As used herein, the term “document consolidator” refers to a business entity which consolidates bills, statements, contracts, debit notes, invoices or other documents from billing entities attached to it. In particularly preferred embodiments, billing entities are linked to document consolidator via leased or dial-up network lines, while in other particularly preferred embodiments, the billing entity is linked to the document consolidator via the Interne.

As used herein, the term “bill payer” is defmed as a customer (business or end-user) of the billing entity.

As used herein, the term “bank” refers to any financial institution able to conduct monetary (i.e., payment) transactions. It is intended that the term encompass commercial banking entities (e.g., Bank of America, Wells Fargo, Citicorp, etc.), as well as credit unions and other entities that are capable of handling funds and transactions. Thus, it is not intended that the term be limited to any particular type of financial institution.

As used herein, the term “Hyperlink” and “link” refers to a navigational link from one document to another, or from one portion (or component) of a document to another. Typically, a hyperlink is displayed as a highlighted word or phrase that can be selected by clicking on it using a mouse to jump to the associated document or documented portion.

As used herein, the term “Interne” refers to a collection of interconnected (public and/or private) networks that are linked together by a set of standard protocols (such as TCP/IP and HTTP) to form a global, distributed network. While this term is intended to refer to what is now commonly known as the Interne, it is also intended to encompass variations which may be made in the future, including changes and additions to existing standard protocols.

As used herein, the terms “World Wide Web” or “Web” refer generally to both (i) a distributed collection of interlinked, user-viewable hypertext documents (commonly referred to as Web documents or Web pages) that are accessible via the Interne, and (ii) the client and server software components which provide user access to such documents using standardized Interne protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

As used herein, the term “Web Site” refers to a computer system that serves informational content over a network using the standard protocols of the World Wide Web. Typically, a Web site corresponds to a particular Internet domain name and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

As used herein, the term “client-server” refers to a model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

As used herein, the term “HTML” refers to HyperText Markup Language which is a standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”).

As used herein, the term “HTTP” refers to HyperText Transport Protocol which is the standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET, causes the server to return the document or file located at the specified URL.

As used herein, the term “URL” refers to Uniform Resource Locator which is a unique address which fully specifies the location of a file or other resource on the Interne. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

As used herein, the term “cookies” refers to a technology that enables a Web server to retrieve information from a user's computer that reveals prior browsing activities of the user. The informational item stored on the user's computer (typically on the hard drive) is commonly referred to as a “cookie.” Many standard Web browsers support the use of cookies.

As used herein, the terms “computer memory” and “computer memory device” refer to any storage media readable by a computer processor. Examples of computer memory include, but are not limited to, RAM, ROM, computer chips, digital video disc (DVDs), compact discs (CDs), hard disk drives (HDD), and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks.

As used herein, the terms “computer processor” and “central processing unit” or “CPU” are used interchangeably and refers to a device that is able to read a program from a computer memory (e.g., ROM or other computer memory) and perform a set of steps according to the program.

As used herein, the term “hosted electronic environment” refers to an electronic communication network accessible by computer for transferring information. One example includes, but is not limited to, a web site located on the world wide web.

As used herein, the term “financial summary” and “financial summaries” refers to both cash flow statements and financial summary values.

### DESCRIPTION OF THE INVENTION

The present invention provides methods and devices for facilitating bill payment. In particular, the present invention provides for electronically facilitated transactions of money between buyers and businesses over a communications network such as the Interne, while providing a convenient and secure way to conduct these types of person-to-person transactions.

Although there are many systems which currently provide bill payers with a single source to view bills and invoices, for instance B2B (business to business) systems like trade hosting server and B2C (business to consumer) systems such as electronic bill presentation. However, until the development of the present invention ease and efficiency of payment was a concern to businesses, consumers, and financial institutions.

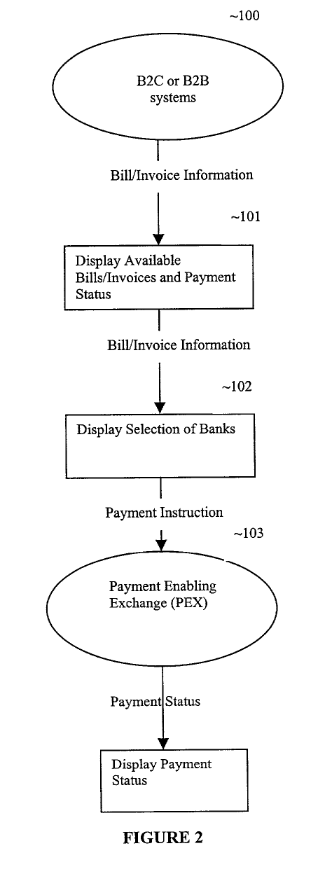

FIG. 2 provides an illustration of the process flow of in B2B systems and B2C systems with PEX Client. As indicated, the bill payer logs onto the system and views the available bills and the payment status for each bill. The bill/invoice information from the system is indicated as well. The payment status is typically indicated as being “outstanding,” “paid,” “debit confirmed,” “partial payment,” or “future payment to be made.” “Outstanding” status indicates the bills which have not been paid, while “paid” indicates that the bills displayed in which the debiting and crediting of the accounts has been completed successfully. For situations in which only the debit account has been successfully debited and the credit account transaction reply message has not been received, the payment status is shown as “debit confirmed.” As soon as the credit account transaction reply message is received, the payment status is changed to “paid.” This only occurs when the transaction is successful. Despite having debited the bill payer's account, the status for failed credit transaction is displayed as “outstanding” in the PEX Client. In addition to displaying the status as “outstanding,” there is a link which leads the payer to a page displaying the “credit failed history.” In addition to the above, payment cancellations can be accomplished using the “future payment” link. Cancellation is only feasible as long as the future payment instruction is not effective. Once the future payment instruction is effective, the status is changed to “debit confirmed,” “paid” or “outstanding,” as appropriate.

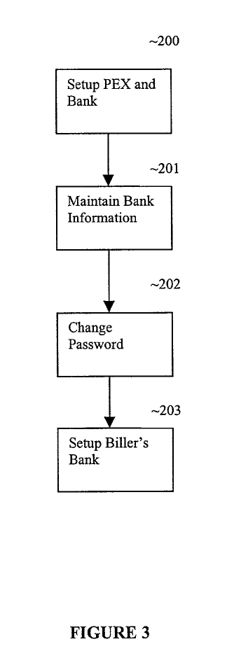

Also as indicated in FIG. 2, the payer has a choice of banks presented on the screen. This prompts the bill payer to select the bank from which the payment is to be debited from the bill payer's account. In preferred embodiments, this “bank selection” is shown when the payer clicks bills with “outstanding” status. All of the banks displayed are registered by the PEX Client Administrator through the Bank Setup process as illustrated in FIG. 3.

Once the payer chooses a bank, they are directed to the payment server of the selected bank. This allows the payer to log into their bank accounts and select the desired debit account number. The bill payer is required to select one of the payment modes available in the bank where the PEX Server resides. Once the payment transaction is made (and in some preferred embodiments, confirmed), payment instruction is sent to the PEX. The PEX Client provides the payment instruction, including the payment and bank information to the corresponding Payment Server in process. The payment server processes the payment instruction and responds to the PEX Client to provide the payment status of the payment instruction. The bill or invoice status is then updated and shown on the “Payment Status” page of the PEX Client. In particularly preferred embodiments, the communication channel from the PEX Client to the payment server is secured with SSL 128-bit technology. A RSA-1024 digital signature algorithm is also implemented to ensure that the required parameters are passed from an authorized system and the data being passed is not tampered with by unauthorized persons.

FIG. 3 provides a schematic of the PEX Client administrative level process flow. In some embodiments, an administrator sets up the payment system and bank in the bill presentation and/or document consolidator system. As indicated in this Figure, the administrator sets up the payment server which resides in the bank connected through the PEX Client. Here, information, including but not limited to the payment server's domain name, bank name, bank access code, bank swift code, etc., are compiled and set up. As there is no limitation on the number of entries, an unlimited number of banks can be set up in the PEX Client. In some embodiments, all of this information is used to display the bank logos on the screen enabling the bill payer or the buyer to choose a bank and connect to the payment server from the bill presentation system and document system and document consolidator system.

Also, as shown in FIG. 3, bank information is maintained, as desired by the user. For example, personal contact numbers or e-mail addresses can be deleted and modified as needed. This is necessary to ensure bank details kept in the PEX Client residing in the bill presentation system and/or document consolidator system are consistent with the bank details kept in the connected payment server.

In addition, as indicated in FIG. 3, a billing entity's bank must be registered in the PEX Client, in order for the payment server to be able to credit the billing entity's account. However, there is no limit as to the number of banks a particular billing entity may register. As long as the billing entity's account in this bank is valid, all the corresponding crediting for every transaction takes place without any exception.

Finally, as depicted in FIG. 3, the PEX Client administrator has the ability to change the password as necessary. In order to change the password, the administrator is required to enter the current password. This is to ensure that the proper authentication takes place before this action can be permitted.

Based on the above, it is clear that the present invention provides methods and devices for facilitating bill payment. In particular, the present invention provides for electronically facilitated transactions of money between buyers and businesses over a communications network such as the Internet, while providing a convenient and secure way to conduct these types of person-to-person transactions.

All publications and patents mentioned in the above specification are herein incorporated by reference. Various modifications and variations of the described methods and devices of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the present invention and claims.

We claim:

1. A method for payment processing between a bill presentation system and a payment server, comprising the steps of:
a) providing:
i) a bill payer having an account,
ii) at least one bank, wherein each bank has a logo,
iii) at least one billing entity,
iv) a payment exchange client,
v) a payment server, and
vi) at least one bill;
b) registering said at least one bank through said payment exchange client;
c) uploading said logo of each bank through said payment exchange client;
d) registering said biller with said bank;
e) generating and exchanging an RSA key pair between said payment exchange client and said payment server, wherein said bill is paid.

2. The method of claim 1, wherein said billing entity is a business.

3. The method of claim 1, wherein said bill payer is selected from the group consisting of businesses and consumers.

4. The method of claim 1, wherein said at least one bill is displayed on a monitor.

5. The method of claim 4, wherein the payment status of said at least one bill is displayed on said monitor.

6. A system comprising a bill payer having an account, at least one bank, at least one billing entity, a payment exchange client, and a payment server, wherein said payment exchange client facilitates payment of bills issued from said billing entity through said payment server and said bank.

7. The system of claim 6, further comprising a means for monitoring transactions between said bill payer and said billing entity.

8. The system of claim 7, wherein said transactions comprise payment of bills.

9. A method for payment processing between a bill presentation system and a payment server, comprising the steps of:
a) providing:
i) a bill payer having an account,
ii) at least one bank, wherein each bank has a logo,
iii) at least one billing entity,
iv) a payment exchange client,
v) a payment server,
vi) a bill presentation site,
vii) at least one bill;
b) registering said at least one bank through said payment exchange client;
c) uploading said logo of each bank through said payment exchange client;
d) registering said biller with said bank;
e) generating and exchanging an RSA key pair between said payment exchange client and said payment server,
f) logging on of said bill payer to said bill presentation site, under conditions such that said at least one bill is displayed on said bill presentation site,
g) selecting said at least one bill for payment and selecting said at least one bank to initiate a payment request; and
h) authorizing the payment of said at least one bill by said at least one bank.

10. The method of claim 9, further comprising the steps of:
i) signing said at least one bill paid by said at least on bank, to produce a signed bill;
j) verifying said signed bill by said payment server to assess the integrity of said signed bill;
k) receiving payment status from said payment server,
l) sending payment status to a document consolidator system
m) updating the status of said at least one bill, and
n) displaying said updated status of said at least one bill.
